(19) United States
(12) Patent Application Publication
(10) Pub. No.: US 2002/0005181 A1
(43) Pub. Date: Jan. 17, 2002

(54) Fluid heating devices

(76) Inventors: Takahiro Moroi, Kariya-shi (JP); Shigeru Suzuki, Kariya-shi (JP); Masami Niwa, Kariya-shi (JP)

Correspondence Address: MORGAN & FINNEGAN, L.L.P., 345 Park Avenue, New York, NY, 10154, US

(21) Appl. No.: 09/905,333

(22) Filed: Jul. 14, 2001

(30) Foreign Application Priority Data
Jul. 14, 2000 (JP) 2000-214602

(51) Int. Cl. F02N 17/02

(52) U.S. Cl. 123/142.5 R

(57) ABSTRACT

Fluid heating devices preferably include a housing defining an actuation chamber and having a suction port and a discharge port. The housing may comprise a front housing and a rear housing. Preferably, at least one of the front housing and/or the rear housing is made of a resin, such as polyphenylene sulfide. A rotor may be rotatably disposed within the actuation chamber. The rotor preferably operates to pressurize fluid drawn from the suction port and to release pressurized fluid from the discharge port. A drive shaft is preferably connected to the rotor. One end portion of the drive shaft may be rotatably supported by the front housing member via a bearing. A throttle may communicate with the pressurized fluid released from the discharge port and apply a braking force to the pressurized fluid.

### BACKGROUND OF THE INVENTION

1. Technical Field

The present invention relates to fluid-heating devices for heating a fluid, such as for example regenerative pumps that can be utilized to circulate and heat a coolant in a vehicle air conditioning/heating system.

2. Description of the Related Art

A known fluid-heating device is disclosed in U.S. Pat. No. 3,720,372 and includes a pump and a throttle. The pump includes a suction port, a discharge port, an actuation chamber and a rotor having a plurality of blades. The rotor is rotatably supported within the actuation chamber and rotation of the rotor draws the fluid through the suction port into the actuation chamber. As a result, the pressure of the fluid increases and high-pressure fluid is discharged from the discharge port to the throttle. The throttle brakes the fluid and thereby causes the fluid temperature to increase. That is, the fluid energy is increased by the rotating rotor and then reduced due to the braking effect. The energy lost by the braking effect is converted into heat.

The known fluid-heating device has a simple construction, can efficiently heat the fluid with high efficiency and can function as a fluid-transporting means. Thus, the fluid-heating device is disposed within an automobile in order to circulate a coolant within the air-conditioning system of the automobile. However, the known fluid-heating device is constructed of metal and is therefore relative heavy, which increases the total weight of the automobile.

### SUMMARY OF THE INVENTION

Therefore, it is an objective of the present invention to provide lighter fluid-heating devices.

Thus, the present teachings provide fluid heating devices having reduced total weight compared to known fluid heating devices. For example, the present fluid heating devices preferably comprise a housing and at least a portion of the housing comprises resin. In a more preferred embodiment, the housing may include at least a front housing and a rear housing and at least one of the front housing and/or the rear housing is made of a resin. More preferably, both the front and rear housing are made of a resin.

Fluid heating devices may naturally include other components, such as a rotor, a drive shaft and a throttle. The housing may include an actuation chamber that defines a suction port and a discharge port. The rotor may be rotatably supported within the actuation chamber in order to pressurize the fluid drawn from the suction port. A drive shaft may be coupled to the vehicle engine and may rotate the rotor. The fluid is pressurized by the rotating rotor and is then released from the discharge port to the throttle. The throttle preferably receives the fluid released from the discharge port and applies a brake to the discharged fluid in order to heat the fluid.

In another preferred aspect of the present teachings, one or more bearings may be disposed within the front housing and one end portion of the drive shaft may be rotatably supported by the front housing member via a bearing. In another preferred aspect of the present teachings, a bearing may be defined within the rear housing and the bearing defined in the rear housing may rotatably support the other end portion of the drive shaft. A passage may be defined within the rear housing in order to communicate fluid to the bearing from the actuation chamber, thereby lubricating the other end of the drive shaft.

Other objects, features and advantage of the present invention will be readily understood after reading the following detailed description together with the accompanying drawings and the claims.

### BRIEF DESCRIPTION OF THE DRAWINGS

FIG. 1 schematically shows a representative coolant circulation circuit in a vehicle air-conditioning system.

FIG. 2 shows a cross-sectional view of a representative heating pump that can be utilized as a fluid-heating device.

FIG. 3 shows a cross-sectional view taken along line 100-100 in FIG. 2.

### DETAILED DESCRIPTION OF THE INVENTION

Representative fluid-heating devices preferably include a housing that is at least partially made of a resin material. More preferably, the housing is entirely made of a resin material. An actuation chamber is preferably defined within the housing and includes a suction port and a discharge port. Further, the housing may comprise at least a front housing member and a rear housing member. At least one of the housing members is made of a resin and as a result, the total weight of the fluid heating device can be reduced. In particular, such light-weight fluid-heating devices may preferably be utilized in vehicle air-conditioning/heating systems. Further, due to the heat-insulating characteristics of resin materials, the resin housing may serve as an insulator that prevents heat from being dissipated from the fluid.

Representative fluid heating devices also may include a rotor rotatably disposed within the actuation chamber. A drive shaft may be connected to the rotor in order to supply a rotational driving force to the rotor. A throttle may be in communication with the discharge port. The rotor may pressurize the fluid drawn from the suction port and the pressurized fluid is released from the discharge port. The front housing member may include at least one bearing that rotatably supports one end portion of the drive shaft. The throttle receives the fluid released from the discharge port to generate heat. According to the present teachings, the term “fluid” may include cooling agents (cooling water, lubricant, etc.), hydraulic fluids, as well as various types of thermally conductive fluids.

The rear housing portion also may include at least one bearing that rotatably supports the other end portion of the drive shaft. Thus, if both ends of the drive shaft are supported by bearings disposed in the front and rear housing members, the rotor can be prevented from tilting and interfering with the inside wall of the housing.

The bearing portion may preferably be defined by a blind hole or a recess provided in the housing member. As the result, the housing member and the bearing portion may be manufactured integrally, and obtain good accuracy. Further, bearing portion defined by a blind hole functions as a bearing and a seal device, so independent bearing parts and a sealing device are not required and therefore, the structure of the representative device can be simplified. Preferably, the fluid within the actuation chamber may be introduced into the bearing portion through a passage to thereby reduce friction between the bearing portion and the drive shaft.

Each of the additional features and method steps disclosed above and below may be utilized separately or in conjunction with other features and method steps to provide improved fluid heating devices and methods for designing and using such fluid heating devices. Representative examples of the present invention, which examples utilize many of these additional features and method steps in conjunction, will now be described in detail with reference to the drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe some representative examples of the invention, which detailed description will now be given with reference to the accompanying drawings.

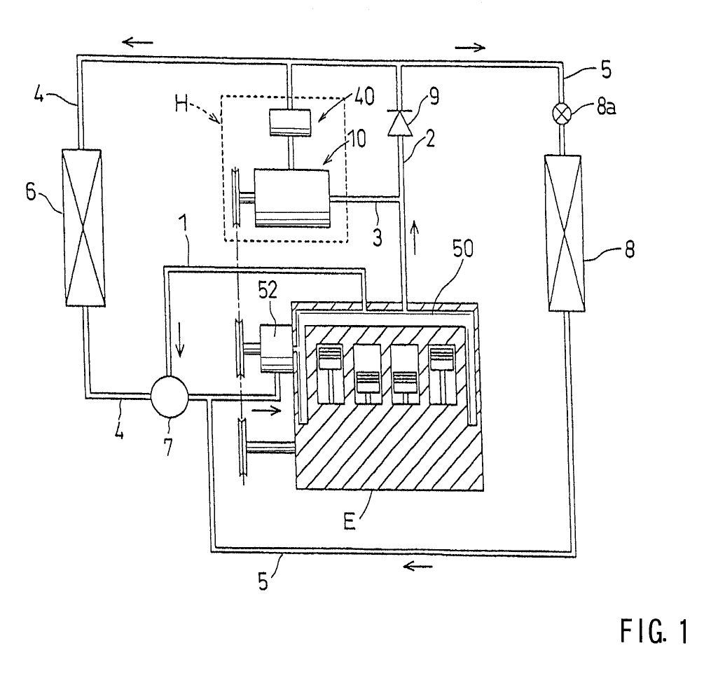

The following representative fluid-heating device may preferably be utilized within a coolant circulation circuit in a vehicle air-conditioning/heating system. As shown in FIG. 1, a vehicle engine E includes a water pump 52 that supplies a coolant (engine coolant) to a water jacket 50. The coolant may, for example, comprise an anti-freeze solution, such as a mixture comprising water and ethylene glycol. As shown in FIG. 1, the coolant circulation circuit may include an engine E, a radiator 6, a thermostat valve 7, a heater core 8, a solenoid valve 8a, a check valve 9, a fluid-heating device H and pipes 1 through 5 that serve to connect these components. Pipes 1 to 3 are located on the downstream side of water jacket 50, while pipes 4 and 5 are located on the upstream side of water jacket 50. Pipe 4 includes a suction-side passage that returns to water pump 52 via radiator 6 and thermostat valve 7. Pipe 5 includes a suction-side passage that returns to water pump 52 via the solenoid valve 8a and the heater core 8. Pipe 1 includes the suction-side passage that leads to thermostat valve 7 from the water jacket 50. That is, the thermostat valve 7 is installed at the branching point between pipe 1 and 4. Pipe 2 includes an outflow passage that connects the water jacket 50 to pipes 4 and 5 via check valve 9. Pipes 2 and 3 are disposed in a parallel relationship between water jacket 50 and pipes 4 and 5.

The water pump 52 is linked to a crankshaft (output shaft) of the engine E via a V-belt. Thus, the engine E supplies a driving force to the water pump 52 and the water pump 52 supplies coolant to the water jacket 50.

The radiator 6 functions as a heat exchanger for dissipating heat from the coolant to the surrounding air or environment. The thermostat valve 7 detects the temperature of the coolant and connects either pipe 1 or 4 to water pump 52 in accordance with the detected temperature. When the temperature detected by thermostat valve 7 is lower than a reference or pre-determined temperature, for example 80° C., the thermostat valve 7 shorts the coolant circulation circuit by connecting pipe 1 to water pump 52, in order to raise the temperature of the coolant using the waste heat of the engine E. To the contrary, when the temperature detected by thermostat valve 7 is higher than the reference or pre-determined temperature, the thermostat valve 7 connects pipe 4 to water pump 52, in order to lower the temperature of the coolant. The radiator 6, thermostat valve 7, and pipe 4 serve as components of a cooling circuit within the vehicle air-conditioning system.

The heater core 8 functions as a heat exchanger for heating the vehicle cabin. The solenoid valve 8a is an on/off valve that controls the supply and shut-off of the coolant to heater core 8 from the engine E in accordance with the heating/cooling conditions of the vehicle air-conditioning system. The heater core 8, solenoid valve 8a, and pipe 5 serve as components of a heating circuit within the vehicle air-conditioning system.

The check valve 9 permits only unidirectional coolant flow from the water jacket 50 to the pipe 4 and 5. If the coolant flow rate via pipe 3 is significantly throttled when the flow through the pipe 1 has been stopped by thermostat valve 7 (i.e., when the radiator 6 is utilized), the check valve 9 opens in order to maintain coolant flow through pipe 4 and/or pipe 5.

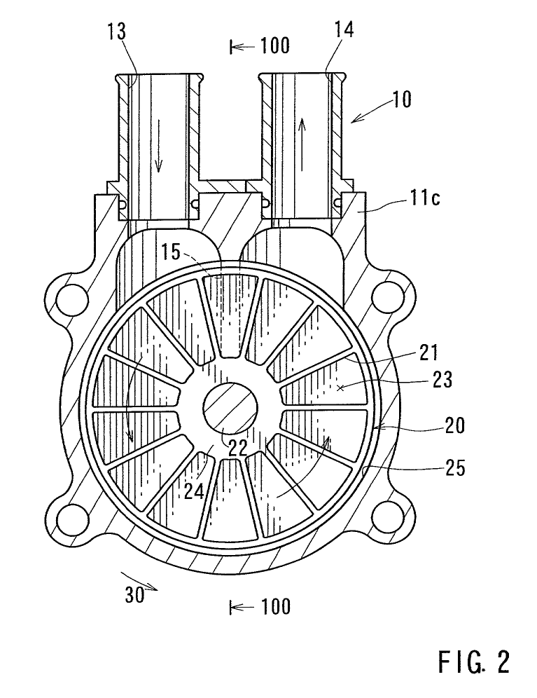

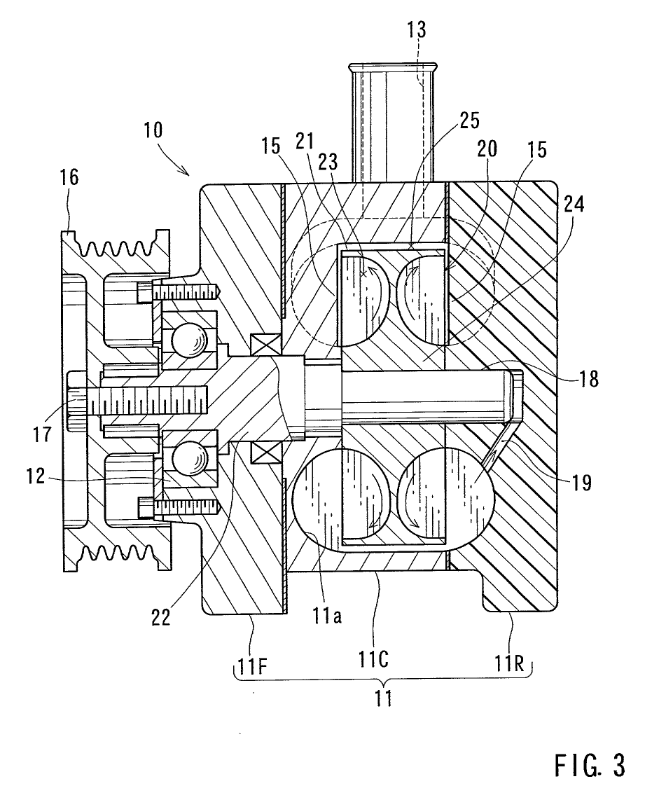

As shown in FIG. 1, the turbine pump-type fluid-heating device H includes a heating pump 10 and a throttling valve 40. As shown in FIGS. 2 and 3, the heating pump 10 includes a rotor 20 that is rotatably supported within a pump housing 11. In this representative embodiment, the pump housing 11 may include a front housing 11F, a center housing 11C and a rear housing 11R. The center housing 11C includes a suction port 13 adapted to draw the coolant into the pump 10 and a discharge port 14 adapted to discharge the coolant pressurized by the rotor 20. A dividing wall 15 is provided in the center housing 11C and the rear housing 11R and serves to separate the suction port 13 from the discharge port 14.

A ring-shaped actuation chamber 25 is formed within the pump housing 11. The actuation chamber 25 is connected to the upstream side of pipe 3 via the suction port 13. In addition, the actuation chamber 25 communicates with the downstream side of pipe 3 (or throttling valve 40) via the discharge port 14. The rotor 20 is integrally coupled to a drive shaft 22 and is installed inside the actuation chamber 25. One end of drive shaft 22 penetrates or protrudes through the center housing 11C and the front housing 11F, and is rotatably supported by the front housing 11F by means of a bearing 12. The end portion of the drive shaft 22 is coupled to a pulley 16 by utilizing a bolt 17. The pulley 16 is linked to the crankshaft (output shaft) of the engine E via a V-belt (shown in FIG. 1).

A bearing portion 18 that is formed as a slide bearing (plane bearing) supports the other end of the drive shaft 22. The rear housing 11R is made of a resin, e.g., polyphenylene sulfide (PPS). The bearing portion 18 is defined by a circular blind hole and the bearing portion rotatably supports the outer surface of the drive shaft 22. Further, the rear housing 11R includes an introduction passage 19 that serves to introduce or supply coolant from the actuation chamber 25 into the bearing portion 18 in order to lubricate the bearing portion 18.

A plurality of blades 21 is disposed on the outer circumference of the rotor 20. In this embodiment, a total of 14 blades are disposed at uniform intervals on both sides of a rotor body 24. The blades 21 radially extend from the rotational center or axis of the rotor body 24. Grooves 23 are formed between these blades 21, which grooves 23 may be, for example, depressions and/or recesses.

When the driving force from engine E rotates the drive shaft 22 and rotor 20, coolant is drawn though the suction port 13 and is pressurized by the rotor 20. The pressurized fluid is then released from the discharge port 14 to the throttling valve 40. In this state, the rotating rotor 20 generates an eddy flow (secondary currents) as indicated by arrows in FIG. 3. As shown in FIG. 3, the eddy flow is generated in the region formed by the grooves 23 of rotor 20 and the grooves 11a formed between the rotor 20 and the center housing 11C (and the rear housing 11R). Each groove 11a has a semi-circular cross section. Therefore, the pressure of the coolant gradually increases due to the coolant flow within each groove 23 and the coolant flow within the actuation chamber 25. Consequently, the heating pump 10 may assist the coolant transportation function of the water pump 52 when the heating pump 10 is operating. The dividing wall 15 of the pump housing 11 and the grooves 23 of the rotor 20 are separated by a small or minute clearance and some high-pressure coolant will leak from the discharge port 14 to the suction port 13 through the clearance. As a result of this internal leakage though the clearance, the fluid is heated within the heating pump 10.

The throttling valve 40 receives the coolant that is released from the discharge port 14. The degree of valve opening can be controlled in throttling valve 40 in order to restrict the flow of coolant through the throttling valve 40. By restricting coolant flow through throttling valve 40, a braking force is applied to the pressurized coolant. This braking effect serves to increase the coolant temperature within the pump 10.

As noted above, the rear housing 11R of the pump housing 11 is preferably made of a resin. The rear housing 11R also preferably has a blind hole that defines the bearing portion 18 in order to support the end portion of the drive shaft 22. The end portion of the drive shaft 22 can directly contact and engage the bearing portion 18 that is defined by the blind hole of the rear housing 10R. Because the rear housing 11R is made of a resin and can support the drive shaft 22 without utilizing independent ball bearings, the structure of the device can be simplified and the weight of the device can be further reduced. The specific gravity (density) of resin materials is generally between 1.3 and 2, while the specific gravity (density) of aluminum is 2.7. Moreover, because resins are generally much better heat insulators than aluminum, the pump housing 11 made of a resin can reduce heat dissipation from the heated coolant.

Further, because the bearing portion 18 is provided in the rear housing 10R, the drive shaft 22 can be supported at two locations along the axial direction, i.e., by the bearing 12 within the front housing 11F and by the bearing portion 18 within the rear housing 11R. Thus, the rotor 20 and the drive shaft 22 can be prevented from tilting during operation. Moreover, the blades 21 can be prevented from interfering with the dividing wall 15, even when the clearance between the dividing wall 15 and the blades 21 is relatively small. The size of the clearance may be reduced in order to reduce the amount of coolant leakage through the clearance.

Further, because the bearing portion 18 can be constructed simply by boring a blind hole into the rear housing 11R, the rear housing 11R can be manufactured more accurately. In addition, because the coolant within the actuation chamber 25 can be introduced into the bearing portion 18 through the passage 19, friction along the sliding surfaces of the bearing portion 18 and the drive shaft 22 can effectively be reduced.

Although only the rear housing 11R is made of a resin in the representative embodiment, the other housing members such as the front housing 11F and/or the center housing 11C also may preferably be made of resin.

Preferably, each blade may be made of steel and may be inserted to the rotor body. Each blade may preferably have a thickness of 1.2 mm or less than 1.2 mm. Relatively thin blade can increase the space defined by the mutually neighboring blades and thus, contributing the effective heat generation, while the steel blade can increase the strength of the blade.

With respect to the structure of the actuation chamber, a fluid introducing passage may preferably connect the high-pressure area (discharge area) to the low-pressure area (suction area). Preferably, the fluid introducing passage may be formed within the dividing wall. Further, a fluid release valve that opens and closes the fluid introducing passage may be adapted in order to release the high-pressure fluid to the low-pressure area. By releasing the high-pressure fluid to the low-pressure area, excessive heat generation can be alleviated. For example, a rotary valve, a ball valve or a lead valve can be utilized for the release valve. Further, a pilot valve for opening the release valve may be installed. The pilot valve may open the release valve with relatively small amount of the fluid and thus, the alleviation control of the heat generation can quickly and precisely be performed. Preferably, the pilot valve may include a spool that can actuate the release valve.

Further, each groove of the pump housing may include a plurality of shield blades at the inner-circumferential side that corresponds to the rotor body (inner circumferential side just close to the drive shaft). The height of the shield blade measured from the inner circumferential surface of the groove in the direction of the outer circumferential surface of the groove may be approximately ⅛ (one eighth) of the height of the actuation chamber measured from the inner circumferential surface of the groove to the outer circumferential surface of the groove. By such structure, heat generating effect can be effectively controlled.

The thickness of the dividing wall in the rotational direction of the rotor can be selected from the various dimensions in relation to the width of the space defined by the mutually neighboring blades with respect to the rotational direction of the rotor. On the other hand, in order to secure the heat generating efficiency and to reduce the noise in operating the fluid heating device, the thickness of the dividing wall in the rotational direction of the rotor may preferably be equal to or wider than the width of the space defined by the mutually neighboring blades with respect to the rotational direction of the rotor. Further, the dividing wall may have groove. Preferably, multiple grooves may be provided on the surface of the dividing wall that faces the rotor blade.

Further techniques for making and using fluid heating devices are taught in a U.S. patent application Ser. No. 09/576,355, a U.S. patent application filed on even date herewith entitled “Fluid Heating Methods and Devices” naming Takahiro Moroi, Masami Niwa, Tatsuyuki Hoshino and Shigeru Suzuki as inventors and claiming Paris convention priority to Japanese patent application Ser. No. 2000-216410 and a U.S. patent application filed on even date herewith entitled “Fluid Heating Devices” naming Takahiro Moroi, Masami Niwa and Shigeru Suzuki as inventors and claiming Paris convention priority to Japanese patent application Ser. No. 2000-216412, all of which are commonly assigned and are incorporated by reference as if fully set forth herein.

1. A fluid heating apparatus comprising:
a housing defining an actuation chamber and having a suction port and a discharge port, the housing comprising at least a front housing and a rear housing, wherein at least one of the front housing and the rear housing is made of a resin,
a rotor rotatably disposed within the actuation chamber, the rotor being operable to pressurize fluid drawn from the suction port and to release pressurized fluid from the discharge port,
a drive shaft connected to the rotor, one end portion of the drive shaft being rotatably supported by the front housing member via a bearing, and
a throttle in communication with the pressurized fluid released from the discharge port, the throttle applying a braking force to the pressurized fluid.

2. A fluid heating apparatus according to claim 1, wherein the rear housing is made of a resin and a bearing is defined within the rear housing, the bearing rotatably supporting one end of the drive shaft.

3. A fluid heating apparatus according to claim 2, wherein the bearing is a blind hole and one end of the drive shaft is disposed within and rotatably engages the blind hole.

4. A fluid heating apparatus according to claim 3, wherein the rear housing includes a passage extending from the actuation chamber to the blind hole, wherein fluid is communicated into the blind hole in order to lubricate the end of the drive shaft.

5. A fluid heating apparatus according to claim 4, wherein the resin is polyphenylene sulfide.

6. A fluid heating apparatus according to claim 2, wherein the bearing is a recess formed within the rear housing one end of the drive shaft is disposed within and rotatably engages the recess.

7. A fluid heating apparatus according to claim 6, wherein the rear housing includes a passage extending from the actuation chamber to the recess, wherein fluid is communicated into the recess in order to lubricate the end of the drive shaft.

8. A fluid heating apparatus according to claim 7, wherein the resin is polyphenylene sulfide.

9. A fluid heating apparatus according to claim 8, further comprising a vehicle engine coupled to the drive shaft, wherein the fluid is a coolant and coolant from the vehicle engine is pressurized within the actuation chamber.

10. A fluid heating apparatus according to claim 2, wherein the rear housing includes a passage extending from the actuation chamber to the bearing, wherein fluid is communicated into the bearing in order to lubricate the end of the drive shaft.

11. A fluid heating apparatus according to claim 10, wherein the resin is polyphenylene sulfide.

12. A fluid heating apparatus according to claim 1, further comprising a vehicle engine coupled to the drive shaft, wherein the fluid is a coolant and coolant from the vehicle engine is pressurized within the actuation chamber.

13. A fluid heating apparatus according to claim 12, wherein the resin is polyphenylene sulfide.
